(19) United States
(12) Patent Application Publication
(10) Pub. No.: US 2008/0002848 A1
(43) Pub. Date: Jan. 3, 2008

(54) Hearing device with a fixing for a hearing tube

(75) Inventors: Markus Heerlein, Singapore (SG); Thomas Kasztelan, Erlangen (DE); Bock Swee Joshua Tan, Singapore (SG)

Correspondence Address: SIEMENS CORPORATION;INTELLECTUAL PROPERTY DEPARTMENT, 170 WOOD AVENUE SOUTH, ISELIN, NJ, 08830, US

(73) Assignee: SIEMENS AUDIOLOGISCHE TECHNIK GMBH

(21) Appl. No.: 11/823,716

(22) Filed: Jun. 28, 2007

(30) Foreign Application Priority Data
Jun. 28, 2006 (DE) 10 2006 029 819.5

(51) Int. Cl. H04R 25/00

(52) U.S. Cl. 381/328; 381/322; 381/330

(57) ABSTRACT

There is described a hearing device, in which a hearing facility is arranged, with the hearing device comprising a connecting piece, which is connected to the hearing facility by way of a hearing tube in order to convey an acoustic signal and/or acoustic signals generated by the hearing facility to an acoustic output of the hearing device, with the hearing tube and the connecting piece being designed as a push fit fitting and being essentially acoustically tight with one another, with the hearing tube and/or the connecting piece comprising at least one projection, which is designed such that it holds the hearing tube in place on the connecting piece.

### CROSS REFERENCE TO RELATED APPLICATIONS

This application claims priority of German application No. 10 2006 029 819.5 EP filed Jun. 28, 2006, which is incorporated by reference herein in its entirety.

### FIELD OF INVENTION

The invention relates to a fixing of a hearing tube in a hearing device.

### BACKGROUND OF THE INVENTION

Hearing devices generally comprise a housing, in which a microphone, an amplifier facility and a receiver are arranged, as well as a power supply. The receiver is connected here to the acoustic output and/or sound outlet of the housing by way of a hearing tube, in order to transmit the acoustic signals generated therefrom. In the case of a hearing device worn behind the ear (BTE), the housing is also connected to a support clasp by way of a connecting piece, said support clasp having a sound channel by way of which the acoustic signals of the receiver are guided to the ear. The hearing tube (in the hearing device) is herewith fixed between the connecting piece and the receiver.

Fixing the hearing tube to the housing and/or the connecting piece by means of adhesive is, as a rule, known from the prior art. The same applies to connecting the hearing tube with the receiver.

U.S. Pat. No. 5,864,628 also discloses a hearing device, which is worn inside the ear. The hearing device comprises a receiver, on the acoustic output of which a connecting section (receiver support) is designed. The connecting section has a barbed clasp in order to fix one end of a hearing tube thereto. On its other end, the hearing tube is fixed in an outlet opening of the housing of the hearing device.

DE 31 41 921 A1 discloses a BTE hearing device having two connecting pieces for an earpiece, with a tubular sound conductor extending through a connecting piece and being inserted with its free end section into a free end section of a sound support, which forms an acoustic output of a receiver of the BTE hearing device.

AT 362 833 discloses an ITE hearing device which is incorporated in an otoplastic, the sound outlet support mounted in ball-joint like manner therein comprising a projection, which holds a sound tube of the otoplastic in place on the sound outlet support.

DE 83 16 771 U1 discloses a BTE hearing device, the sound tube of which is held in place on the receiver by means of a flaring of the sound outlet support of a receiver of the BTE hearing device. The sound tube opens out into a line of a support clasp, which is attached to the BTE hearing device.

Adhesive as a fixing means nevertheless has the following disadvantages.

Adhesive thinners allow the parameters of the converter, such as the receiver and microphone for instance, to be damaged. A further disadvantage is that the adhesive ages with time and herewith becomes brittle and crumbly. The tightness of the adhesive connection herewith increasingly reduces.

It has also transpired if the drop tests increase in speed, the hearing tube easily loosens away from the connecting piece and/or detaches completely. During drop tests, the receiver likewise loosens or completely detaches from the hearing tube.

A loosening or even detachment of the connection between the hearing tube and receiver and/or hearing tube and housing connection results in the respective connection at least being untight. This in turn leads to the production of unwanted acoustic feedback between the receiver and the microphone, since the acoustic signal of the receiver can reach the interior of the housing. The attenuated signal is recorded by the microphone, converted into an electrical signal, subsequently amplified and conveyed to the receiver. There the signal is reconverted into an acoustic signal and made noticeable to the wearer of the hearing device by means of an unpleasant whistling. If the hearing tube is completely detached, the hearing device is completely unusable.

A further disadvantage is that the manufacturing tolerances for the connection of the hearing tube with the housing connection and/or with the receiver by means of adhesive are relatively small in order to guarantee an acoustically tight connection.

It is likewise disadvantageous that the hearing tube cannot be easily exchanged. To this end, the hearing tube must first be detached from its adhesive connection with the housing and/or the receiver and must subsequently be reaffixed thereto.

### SUMMARY OF INVENTION

An object of the invention is thus to provide a suitable fixing for a hearing tube on a housing of a hearing device, which ensures that the fixing is not damaged even when the hearing device is dropped and also does not require the use of an adhesive.

This object is achieved in accordance with the invention by developing the hearing tube with the corresponding housing connecting piece and/or section as a push fit fitting, which allows an essentially acoustically tight connection, with the hearing tube and/or the connecting piece comprising at least one projection, which also holds in place and/or fixes the hearing tube and the connecting piece.

This is advantageous in that the hearing tube can be permanently connected to the housing without having to use an adhesive. A further advantage is that, in contrast to the fixing by means of adhesive, larger manufacturing tolerances are possible with the production of the hearing tube and the corresponding connecting piece, with an essentially acoustically tight connection of preferably 100% being able to be achieved.

Furthermore, the provision of the projection also retains the fixing so that even if the hearing device drops it does not loosen or detach in contrast to the fixing by means of adhesive. It is also ensured that the connection of the hearing tube is acoustically tight, so that the occurrence of acoustic feedbacks is essentially prevented. A further advantage is that the hearing tube can be easily removed from one end for cleaning without it first having to be loosened from its adhesive connection, as in the prior art, and subsequently having to be readhered thereto.

Further preferred embodiments are described in the subclaims.

In a preferred embodiment, the hearing tube and the hearing facility are likewise configured as a push fit fitting, with the hearing tube and/or the hearing facility and/or the connecting section thereof being provided with at least one projection. This is advantageous in that the hearing facility can be reliability fastened to the hearing tube and does not loosen or detach even if the hearing device is dropped. Furthermore, the hearing tube can be completely exchanged without any problem.

In a further preferred embodiment of the invention, the projection is designed to be circular or partially circular. A circular projection, which is arranged for instance on the connecting piece, is advantageous in that the hearing tube, if it is push fitted onto and/or moved onto the connecting piece, rests against on the projection over the entire periphery and the tightness of the fixing can thus additionally be improved.

In a further preferred embodiment, the projection is configured in the form of a barbed clasp or a tappet. The configuration as a barbed clasp, as shown for instance in FIG. 3, is advantageous in that the hearing tube can be easily moved onto the housing connecting piece. In the event of an opposite movement, the clasp tilts in the opposite direction and generates an additional hold of the hearing tube on the connecting piece.

In one embodiment of the invention, at least one recess or groove is arranged opposite to the projection so that the projection can engage or lock into the recess when the hearing tube is joined with the corresponding connecting piece. This is advantageous in that the hold and the tightness between the hearing tube and the housing connecting piece and/or between the hearing tube and the hearing connecting section can be further improved.

### BRIEF DESCRIPTION OF THE DRAWINGS

The invention is described in more detail in the appended diagrams with reference to preferred embodiments, in which:

FIG. 1 shows a section of a BTE with an inventive fixing of a hearing tube,

FIG. 2 shows an exploded view of individual components of the BTE according to FIG. 1,

FIG. 3 shows a partial view of the BTE hearing aid device according to FIGS. 1 and 2,

FIG. 4a to 4c shows an embodiment of a connecting piece according to the invention, with a view from below (FIG. 4a), a front sectional view (FIG. 4b), and a section of a connecting section (FIG. 4c), which connects a housing to a support clasp, and

FIGS. 5a and 5b shows different embodiments of the connection between the hearing tube and a hearing connecting section and/or a housing connecting piece.

### DETAILED DESCRIPTION OF INVENTION

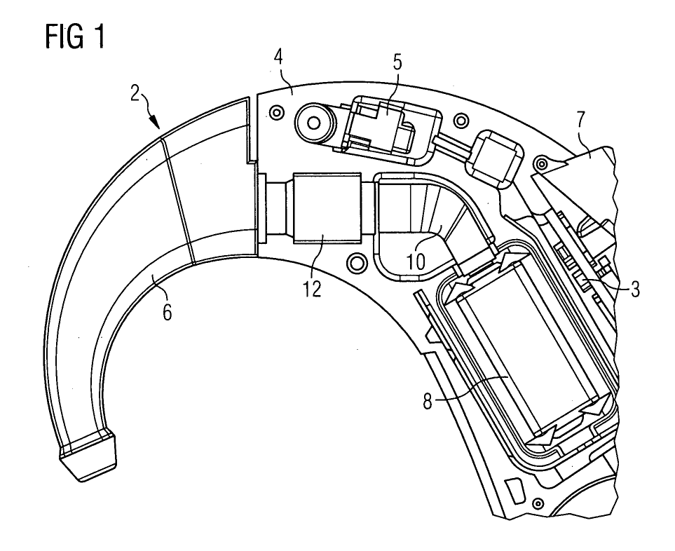

FIG. 1 shows a part of a BTE hearing device 2, which comprises a housing 4 and a support clasp 6 connected to the housing 4. A receiver and/or a hearing facility 8, an amplifier facility 3, a microphone facility 5 and a power supply facility (not shown) are arranged inter alia in the housing 4. Furthermore, a button or switch 7 can be provided to switch the hearing device 2 on/off. The hearing facility 8 is connected to a housing connecting piece 12 by way of a hearing tube 10, said housing connecting piece 12 connects the housing 4 with the support clasp 6.

By way of the hearing tube (10), the acoustic signal generated by the hearing facility 8 is conveyed into the sound channel of the support clasp 6 via the housing connecting piece 12. The acoustic signal is then forwarded into a human ear, in a tube (not shown) fixed to the end of the support clasp 6 by way of an otoplastic.

The hearing tube 10 preferably consists of a flexible material such as for instance a rubber material, a fluorosilicon or viton, in order to attenuate the receiver 8 oscillations. The hardness range of the materials lies for instance between 15-60 SHA.

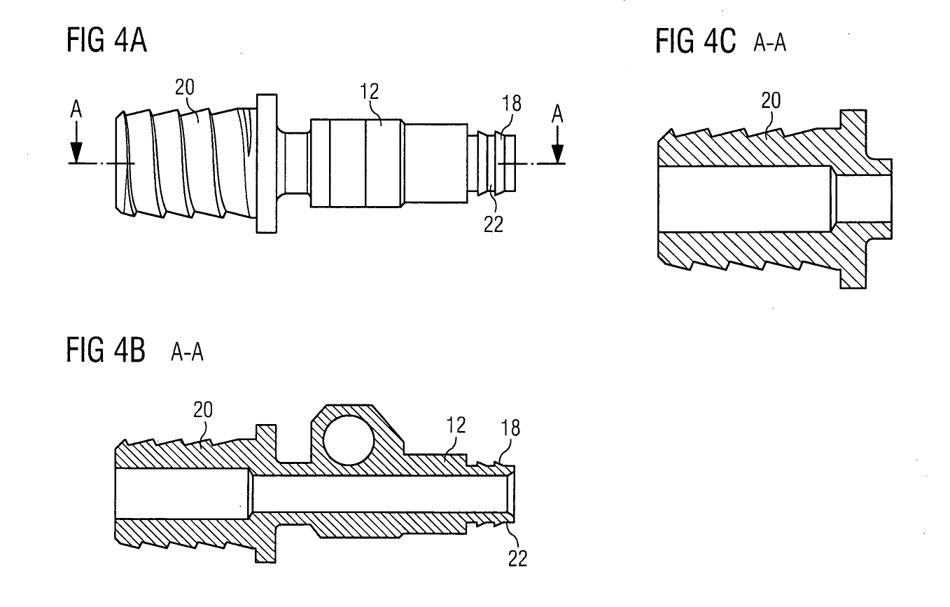

The housing connecting piece 12, as shown in FIGS. 1 to 4, can be made out of plastic and/or metal and/or metal alloy. Metal is advantageous in that by virtue of its weight, the housing connecting piece 12 does not essentially transmit any vibrations onto the support clasp 6. The housing connecting piece 12 is designed such that it connects the housing 4 to the support clasp 6. To this end, the housing connecting piece 12, as shown in FIGS. 4a to c, has a thread on its end 20, which is screwed into the support clasp 6. Furthermore, the housing connecting piece 12, as shown in FIG. 4b, has a bore for also fixing to the housing 4.

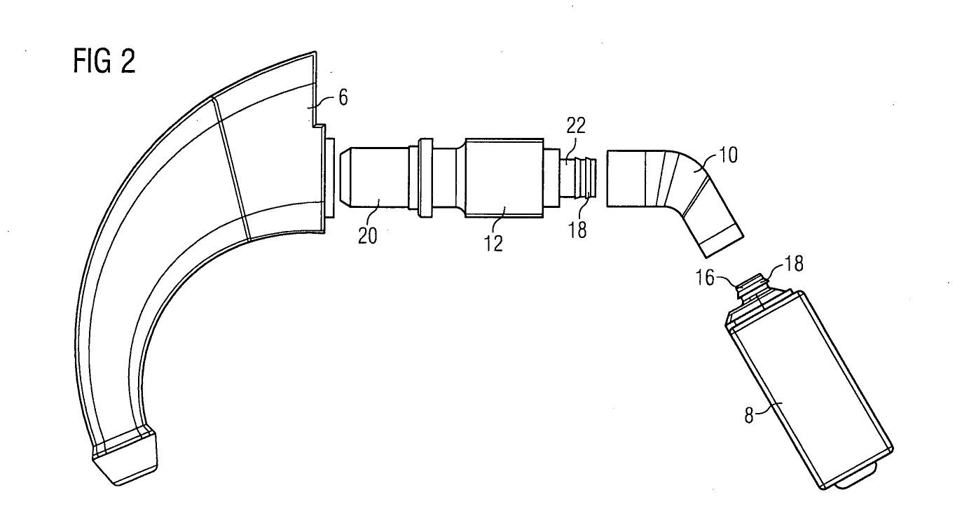

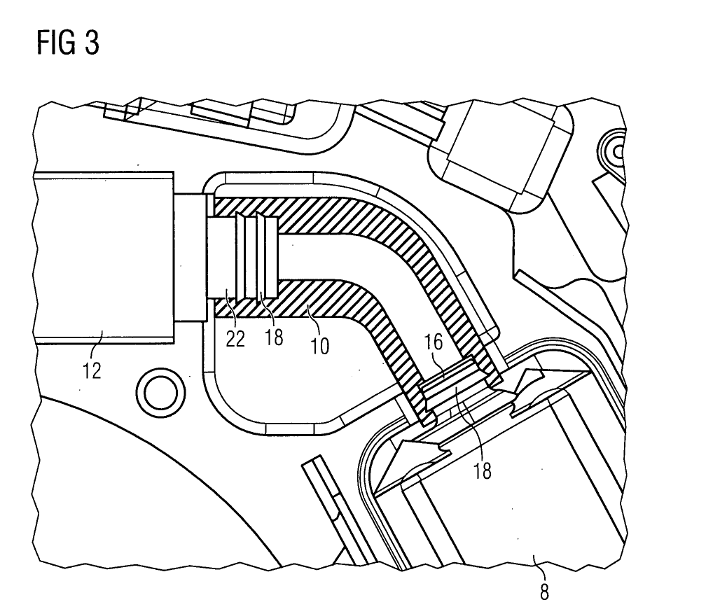

To connect the hearing facility 8 (see FIG. 2) to the hearing tube 10, the hearing facility 8 has at least one projection 18 on its connecting section 16, in one embodiment of the invention, as is seen in FIGS. 2 and 3.

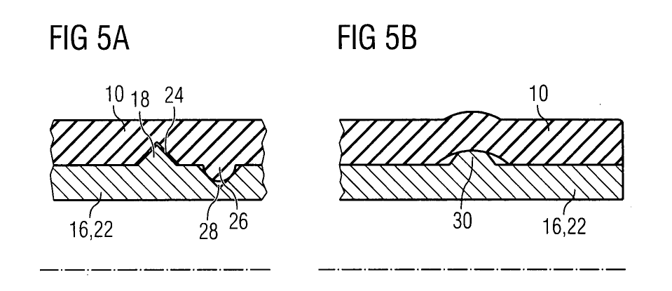

The projection 18 can be designed here for instance as a circular or at least partially circular tappet, as shown in FIGS. 5a and 5b, or as a clasp or in the form of a stud. The dimensions such as height and width as well as the form of the tappet and/or clasp or stud can be varied depending on requirements.

The embodiment is advantageous in that the hearing tube 10 can be moved or pushed onto the connecting piece 16 of the hearing facility 8 and can be held in position by the projection 18. The hearing tube 10 forms here an essentially acoustically tight connection with the connecting section 16. Furthermore, the internal diameter and the material of the hearing tube 10 is preferably selected such that after the fixing, it is sufficiently secure and is essentially flush with the connecting section 16 and its projection 18 in order to ensure an acoustic tightness of preferably 100%.

An acoustically tight connection means here that essentially no acoustic signal and/or sound can escape from the hearing tube 10 to the connecting section 16 by way of the fixing. This is advantageous in that the hearing facility 8 cannot be loosened or detached from the hearing tube 10 if the hearing device 2 is dropped. By virtue of the acoustically sealed connection, no disturbing acoustic feedbacks occur.

An end section 22 of the housing connecting piece 12, as is shown in FIGS. 2, 4 and 5, can be likewise provided with at least one projection 18. The projection 18 can be designed here as a circular or at least partially circular tappet or clasp, or in the form of a stud. The dimensions such as height and width, as well as the form of the tappet and/or clasp or stud can in turn likewise be varied depending on requirements.

In further inventive embodiments, the hearing tube 10, as shown in FIG. 5a, can for instance optionally be provided with one (or a number of) corresponding additional recess(es) 24, into which the projection 18 can engage or lock. This is advantageous in that the hold and the tightness between the connecting section 16 of the hearing facility 8 and the hearing tube 10 and/or between the housing connecting piece 12 and the hearing tube 10 can also be improved.

Furthermore, the hearing tube 10 can alternatively or additionally be provided with at least one projection 26, as is shown in FIG. 5a. The projection 26 can engage or lock into a corresponding recess 28, which can be designed on the hearing connecting section 16 and/or on the housing connecting piece 12.

In a further embodiment of the invention, as shown in FIG. 5b, the hearing tube 10 can comprise a section region with a flat surface, which is displaced over a projection, e.g. a tappet 30 of the corresponding connecting piece 16, 22, and preferably rests flat thereagainst.

The projection 18 can be designed in the form of a clasp, as is shown in FIGS. 2 and 3.

A combination of the said embodiments is possible, particularly the combination of individual features.

The embodiment according to the invention is advantageous in that the receiver 8 and the hearing tube 10 and/or the housing connecting piece 12 and the hearing tube 10 cannot loosen from one another should a drop test increase in speed. Furthermore, the hearing tube 10 can be easily removed for cleaning and can be reinserted into the hearing device 2.

The present invention is not restricted to BTE hearing devices/BTE hearing aid devices 2, but is also suited to other hearing device types, such as ITE hearing devices for instance. With ITE hearing devices, a connecting section can be provided on the acoustic output of the housing for instance for BTE hearing device 2, instead of the housing connecting piece 12 as shown in FIGS. 2 and 3. The connecting section can be designed as a separate insert, and can be fixed to the housing fixing methods known to the person skilled in the art.

Alternatively, the connecting section can also be designed in one piece with the housing and can be molded thereto. The connecting section 16 and/or the hearing tube 10 are also designed here as a push fit fitting, as detailed above in respect of FIGS. 1 to 5. The hearing tube 10 and/or the connecting piece 16 are designed here with at least one projection 18.

The hearing device according to the invention includes hearing devices for people with hearing difficulties, such as the hard of hearing, as well as for any other type of hearing device and/or hearing aid devices, which are used to transmit acoustic signals. This also includes so-called headsets, as are used with cell phones for instance.

1.-10. (canceled)

11. A hearing device, comprising:
an acoustic output;
a hearing facility;
a connecting piece connected to the hearing facility via a hearing tube to convey an acoustic signal generated by the hearing facility to the acoustic output;
a first push fit fitting connection between the hearing tube and the connecting piece, wherein the first push fit connection is substantially acoustically tight, wherein the hearing tube has a projection, or the connecting piece has a projection, or the hearing tube and the connecting piece have a projection, and wherein the projection holds the hearing tube in place on the connecting piece; and
a second push fit fitting connection between the hearing facility and the hearing tube, wherein the second push fit connection is substantially acoustically tight, wherein the hearing tube has a projection, or the hearing facility has a projection, or the hearing tube and the hearing facility have a projection, and wherein the projection holds the hearing tube in place on the hearing facility.

12. The hearing device as claimed in claim 11, wherein at least one projection is a circular projection.

13. The hearing device as claimed in claim 11, wherein at least one projection is a partially circular projection.

14. The hearing device as claimed in claim 11, wherein at least one projection is of a certain type, wherein the type is selected from the group consisting of a barbed clasp type, a tappet type and a stud type.

15. The hearing device as claimed in claim 11, wherein the hearing tube, or the connecting piece, or the hearing tube and the connection piece have a recess or groove for at least one projection.

16. The hearing device as claimed in claim 11, wherein the hearing tube or the hearing facility or the hearing tube and the hearing facility have a recess or groove into which the projection can engage or lock.

17. The hearing device as claimed in claim 11, wherein the hearing device is to be worn behind the ear.

18. The hearing device as claimed in claim 17, wherein the connecting piece is a separate part, and wherein the connecting piece connects a housing of the hearing device with a support clasp.

19. The hearing device as claimed in claim 11, wherein the hearing device is to be worn in the ear.

20. The hearing device as claimed in claim 11, wherein the hearing device is to be worn in an auditory canal.

21. The hearing device as claimed in claim 11, wherein connecting piece and a housing of the hearing device are one piece.

22. The hearing device as claimed in claim 11, wherein the connecting piece is made out of metal or a metal alloy.

23. The hearing device as claimed in claim 11, wherein the hearing tube is made of fluorosilicon.

24. The hearing device as claimed in claim 11, wherein the hearing tube is made of viton.

25. The hearing device as claimed in claim 11, wherein the hearing tube is made out of a flexible material with a hardness in the range between 15 and 60 SHA.

26. The hearing device as claimed in claim 11, wherein the hearing device is a headset.
